(19) United States
(12) Patent Application Publication
(10) Pub. No.: US 2026/0043186 A1
(43) Pub. Date: Feb. 12, 2026

(54) DISPENSING FLUIDS BASED ON A FLOW CHARACTERISTIC

(71) Applicant: Delaware Capital Formation, Inc., Wilmington, DE (US)

(72) Inventor: Christopher James Dyer, South Warnborough (GB)

(21) Appl. No.: 18/986,265

(22) Filed: Dec. 18, 2024

Related U.S. Application Data
(60) Provisional application No. 63/612,526, filed on Dec. 20, 2023.

(51) Int. Cl. D06F 39/02; D06F 34/14; D06F 103/00; D06F 105/42; G05D 11/13

(52) U.S. Cl. CPC D06F 39/028; D06F 34/14; D06F 39/022; G05D 11/132; D06F 2103/00; D06F 2105/42

(57) ABSTRACT

Systems and method for dispensing chemical include an eductor having a diluent inlet, a chemical pickup port, a discharge port, and a venturi fluidly coupled between the diluent inlet and the discharge port; a selector valve fluidly coupled to the diluent inlet and configured to control a flow of diluent into the diluent inlet; a sensor configured to measure a flow characteristic of the flow of diluent; and a controller operatively coupled to the selector valve. The controller includes at least one processor and memory storing instructions that, when executed, cause the at least one processor to perform operations including opening the selector valve to allow the flow of diluent into the diluent inlet; determining a dispense duration based on the measured flow characteristic and an amount of a chemical to be dispensed; and in response to determining that the dispense duration has elapsed, closing the selector valve.

### CROSS-REFERENCE TO RELATED APPLICATION

This application claims the benefit under 35 U.S. C. § 119(e) of U.S. Patent Application No. 63/612,526, entitled “Dispensing Fluids Based On A Flow Characteristic,” filed Dec. 20, 2023, which is incorporated herein by reference in its entirety.

### TECHNICAL FIELD

The present disclosure relates to dispensing fluids.

### BACKGROUND

The dispensing of liquid chemical products into a receptacle or machine is a common requirement of many industries. For example, in a laundry environment it is often desirable to dispense one or more chemicals, such as detergents, bleaches, disinfectants, sanitizers, etc., for use in industrial laundry machines. Such chemicals may be dispensed directly into the machine and mixed with water or other diluent to form a solution. A number of dispensing systems have been developed for this purpose. For example, many systems use a chemical reservoir and a control valve to deliver chemical directly to the machine or receptacle. The control valve can be configured as an electronic or pneumatic valve. In many applications, the system can include a way to meter the amount of chemical being dispensed into the machine or receptacle.

### SUMMARY

Chemical dispensing systems can include one or more eductors to dispense an amount of a chemical. In general, chemical dispensing systems including eductors can deliver accurate and repeatable doses of chemicals; however, the accuracy of the chemical dose is dependent on flow characteristics of the diluent and specific flow characteristics of the chemical being dispensed. For example, if the flow rate or pressure of the diluent flow decreases below a nominal operating flow rate or pressure, the amount of chemical dispensed can be less than the expected amount. Likewise, if the flow rate or pressure of the diluent flow increases above the nominal operating flow rate or pressure, more than the expected amount of chemical can be dispensed. Some chemicals include fillers or other materials that affect how the chemical flows. Additionally, chemical flow characteristics can depend on temperature, pressure, and applied shear stress (e.g., the viscosity of non-Newtonian fluids varies based on applied shear stress).

This disclosure describes systems and methods for dispensing fluids based on a flow characteristic of a diluent flow.

In an example implementation, a chemical dispensing system includes an eductor having a diluent inlet, a chemical pickup port, a discharge port, and a venturi fluidly coupled between the diluent inlet and the discharge port; a selector valve fluidly coupled to the diluent inlet and configured to control a flow of diluent into the diluent inlet; a sensor configured to measure a flow characteristic of the flow of diluent; a controller operatively coupled to the selector valve, the controller including at least one processor and memory storing instructions that, when executed, cause the at least one processor to perform operations including opening the selector valve to allow the flow of diluent into the diluent inlet; determining a dispense duration based on the measured flow characteristic and an amount of a chemical to be dispensed; and in response to determining that the dispense duration has elapsed, closing the selector valve.

In an aspect combinable with the example implementation, the sensor includes a pressure sensor coupled to the system upstream of the diluent inlet and the flow characteristic including a pressure of the flow of diluent.

Another aspect combinable with any of the previous aspects includes a flow meter coupled to the system upstream of the diluent inlet and configured to measure a flow rate of the flow of diluent.

In another aspect combinable with any of the previous aspects, the sensor includes a flow meter coupled to the system upstream of the diluent inlet and the flow characteristic includes a flow rate of the flow of diluent.

In another aspect combinable with any of the previous aspects, the memory of the controller stores dispense duration calibration data.

In another aspect combinable with any of the previous aspects, the calibration data includes a plurality of curves of chemical flow rates based on the measured flow characteristic, each curve corresponding with a particular chemical.

In another aspect combinable with any of the previous aspects, the calibration data further includes a plurality of curves of chemical flow rates based on an installation configuration of the chemical dispensing system, each curve corresponding to a particular installation configuration and a particular chemical.

In another aspect combinable with any of the previous aspects, determining the dispense duration includes determining an expected flow rate of the particular chemical to be dispensed based on the measured flow characteristic; and determining the dispense duration based on the flow rate and the amount of the chemical to be dispensed.

Another aspect combinable with any of the previous aspects includes a chemical reservoir fluidly coupled to the chemical pick up port.

In another aspect combinable with any of the previous aspects, the discharge port is fluidly coupled to one or more laundry machines.

In another aspect combinable with any of the previous aspects, the selector valve is a first selector valve and the eductor is a first eductor, and the system further includes a second eductor having a diluent inlet, a chemical pickup port, a discharge port, and a venturi fluidly coupled between the diluent inlet and the discharge port; a second selector valve fluidly coupled to the diluent inlet of the second eductor; an inlet manifold fluidly coupled to the first and second selector valves and configured to be coupled to a source of diluent; and a flush manifold fluidly coupled to the discharge ports of the first and second eductors.

In another aspect combinable with any of the previous aspects, the chemical pick up ports of the first and second eductors are fluidly coupled to different chemical reservoirs.

In another aspect combinable with any of the previous aspects, the second eductor is a flush eductor.

In another aspect combinable with any of the previous aspects, the operations include opening the second selector valve for a flush duration to flush the flush manifold with diluent.

In another aspect combinable with any of the previous aspects, the operations further include determining a second dispense duration to dispense a second chemical fluidly coupled to the pickup port of the second eductor; opening the second selector valve for the second dispense duration; and in response to determining that the second dispense duration has elapsed, closing the second selector valve.

In another example implementation, a method for dispensing a fluid includes opening a selector valve fluidly coupled to a diluent inlet of an eductor to allow the flow of diluent into the diluent inlet, the eductor including the diluent inlet, a chemical pickup port, a discharge port and a venturi fluidly coupled between the diluent inlet and the discharge port; measuring a flow characteristic of a diluent flow using a sensor; determining a dispense duration based on the measured flow characteristic and an amount of a chemical to be dispensed; and in response to determining that the dispense duration has elapsed, closing the selector valve.

In an aspect combinable with the example implementation, the sensor includes a pressure sensor and measuring the flow characteristic including measuring a pressure of the flow of diluent.

Another aspect combinable with any of the previous aspects includes measuring a flow rate of the flow of diluent using a flow meter fluidly coupled to the diluent inlet.

In another aspect combinable with any of the previous aspects, the sensor includes a flow meter and measuring the flow characteristic includes measuring a flow rate of the flow of diluent.

In another aspect combinable with any of the previous aspects, measuring the flow characteristic includes determining an average value of the flow characteristic over a period of time, and determining the dispense duration is based on the average value of the flow characteristic.

In another aspect combinable with any of the previous aspects, determining the dispense duration includes determining a flow rate of the chemical to be dispensed based on the measured flow characteristic; and determining the dispense duration based on the flow rate and the amount of the chemical to be dispensed.

Another aspect combinable with any of the previous aspects includes opening a second selector valve to flush a flush manifold with diluent; and in response to determining that a flush duration has elapsed, closing the second selector valve.

Another aspect combinable with any of the previous aspects includes determining a second dispense duration to dispense a second chemical fluidly coupled to the pickup port of a second eductor, the second dispense duration being based on the measured flow characteristic and an amount of the second chemical to be dispensed; opening a second selector valve; and in response to determining that the second dispense duration has elapsed, closing the second selector valve.

Another aspect combinable with any of the previous aspects includes determining that the measured flow characteristic is outside of an operating range of the eductor; and in response, generating an alert indicating that the measured flow characteristic is outside of the operating range.

In another aspect combinable with any of the previous aspects, generating the alert includes causing a light on a control panel to blink, generating an audible alarm, or generating a text-based message.

In another example implementation, one or more non-transitory, machine-readable storage devices storing instructions for dispensing a fluid, the instructions being executable by one or more processors, to cause performance of operations including opening a selector valve fluidly coupled to a diluent inlet of an eductor to allow the flow of diluent into the diluent inlet, the eductor including the diluent inlet, a chemical pickup port, a discharge port and a venturi fluidly coupled between the diluent inlet and the discharge port; measuring a flow characteristic of a diluent flow using a sensor; determining a dispense duration based on the measured flow characteristic and an amount of a chemical to be dispensed; and in response to determining that the dispense duration has elapsed, closing the selector valve.

In an aspect combinable with the example implementation, the sensor includes a pressure sensor and measuring the flow characteristic includes measuring a pressure of the flow of diluent.

In another aspect combinable with any of the previous aspects, the operations further include measuring a flow rate of the flow of diluent using a flow meter fluidly coupled to the diluent inlet.

In another aspect combinable with any of the previous aspects, the sensor includes a flow meter and measuring the flow characteristic includes measuring a flow rate of the flow of diluent.

In another aspect combinable with any of the previous aspects, measuring the flow characteristic includes determining an average value of the flow characteristic over a period of time, and where determining the dispense duration is based on the average value of the flow characteristic.

In another aspect combinable with any of the previous aspects, determining the dispense duration includes determining a flow rate of the chemical to be dispensed based on the measured flow characteristic; and determining the dispense duration based on the flow rate and the amount of the chemical to be dispensed.

In another aspect combinable with any of the previous aspects, the operations further include opening a second selector valve to flush a flush manifold with diluent; and in response to determining that a flush duration has elapsed, closing the second selector valve.

In another aspect combinable with any of the previous aspects, the operations further include determining a second dispense duration to dispense a second chemical fluidly coupled to the pickup port of a second eductor, the second dispense duration being based on the measured flow characteristic and an amount of the second chemical to be dispensed; opening a second selector valve; and in response to determining that the second dispense duration has elapsed, closing the second selector valve.

In another aspect combinable with any of the previous aspects, the operations further include determining that the measured flow characteristic is outside of an operating range of the eductor; and in response, generating an alert indicating that the measured flow characteristic is outside of the operating range.

In another aspect combinable with any of the previous aspects, generating the alert includes causing a light on a control panel to blink, generating an audible alarm, or generating a text-based message.

In another example implementation, a method for calibrating a chemical dispensing system includes opening a selector valve fluidly coupled to a diluent inlet of an eductor to allow a flow of diluent into the diluent inlet; measuring a flow characteristic of the flow of diluent; closing the selector valve after an amount of time; determining an amount of chemical dispensed during the amount of time; determining an average value of the measured flow characteristic; and recording a flow rate of the chemical dispensed at the average value of the measured flow characteristic based on the amount of chemical dispensed and the amount of time.

In an aspect combinable with the example implementation, measuring a flow characteristic of the flow of diluent includes measuring a pressure of the flow of diluent.

Another aspect combinable with any of the previous aspects includes measuring a flow rate of the flow of diluent using a flow meter fluidly coupled upstream of the diluent inlet.

In another aspect combinable with any of the previous aspects, measuring the flow characteristic includes measuring a flow rate of the flow of diluent.

Another aspect combinable with any of the previous aspects includes for a plurality of different values of the flow characteristic, iteratively performing opening the selector valve fluidly coupled to the diluent inlet of an eductor to allow the flow of diluent into the diluent inlet; measuring the flow characteristic of the flow of diluent; closing the selector valve after an amount of time; determining the amount of chemical dispensed during the amount of time; determining the average value of the measured flow characteristic; and recording the flow rate of the chemical dispensed at the average value of the measured flow characteristic based on the amount of chemical dispensed and the amount of time.

Another aspect combinable with any of the previous aspects includes constructing a chemical signature curve based on the recorded flow rate of chemical dispensed and the average value of the measured flow characteristic.

Another aspect combinable with any of the previous aspects includes for a plurality of different installation configurations, iteratively performing opening the selector valve fluidly coupled to the diluent inlet of an eductor to allow the flow of diluent into the diluent inlet; measuring the flow characteristic of the flow of diluent; closing the selector valve after an amount of time; determining the amount of chemical dispensed during the amount of time; determining the average value of the measured flow characteristic; and recording the flow rate of the chemical dispensed at the average value of the measured flow characteristic based on the amount of chemical dispensed and the amount of time.

Particular implementations of the subject matter described in this specification can be implemented to realize one or more of the following advantages. Determining a dispense duration based on a flow characteristic of diluent flow can improve the accuracy of chemical doses across a range of diluent flow conditions. For example, if the diluent pressure decreases or increases relative to a nominal pressure, the controller can determine an accurate dispense duration for the given condition based on the chemical signature of the chemical being dispensed. The chemical dispensing system can determine when the flow characteristic of the diluent flow are outside of effective operating limits of the system (e.g., due to no diluent flow, limited diluent flow, fluctuating diluent flow, diluent flow not maintained for the entire dispense duration). The chemical dispensing system can generate an alarm to notify a user that the diluent flow is outside of the effective limits. Chemical signatures can be implemented for each chemical that will be dispensed by using the chemical dispensing curves which can improve dosing accuracy irrespective of chemical transport properties (e.g., viscosity). Chemical signatures can be determined in a laboratory environment for each chemical and for standardized system configurations and implemented in deployed systems meeting the standardized system configurations without further calibration, which improves the usability and decreases maintenance and installation time.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for dispensing chemicals.

FIG. 2 is a schematic diagram of the cross-section of an eductor.

FIG. 3 is a flow chart of an example process to dispense chemicals using the system of FIG. 1.

FIGS. 4A-4B are plots of example chemical signatures.

FIG. 5 is an example method for calibrating a chemical dispensing system.

FIG. 6 is a front view of an example chemical dispenser.

FIG. 7 is a bottom view of the dispenser of FIG. 5.

FIG. 8 is a back view of the dispenser of FIG. 5.

FIG. 9 is a perspective view of the dispenser of FIG. 5.

FIG. 10 is an exploded perspective view of the dispenser of FIG. 5.

FIG. 11 is an exploded perspective view of an example controller.

FIG. 12 shows a schematic drawing of a control system.

Like reference symbols in the various drawings indicate like elements.

### DETAILED DESCRIPTION

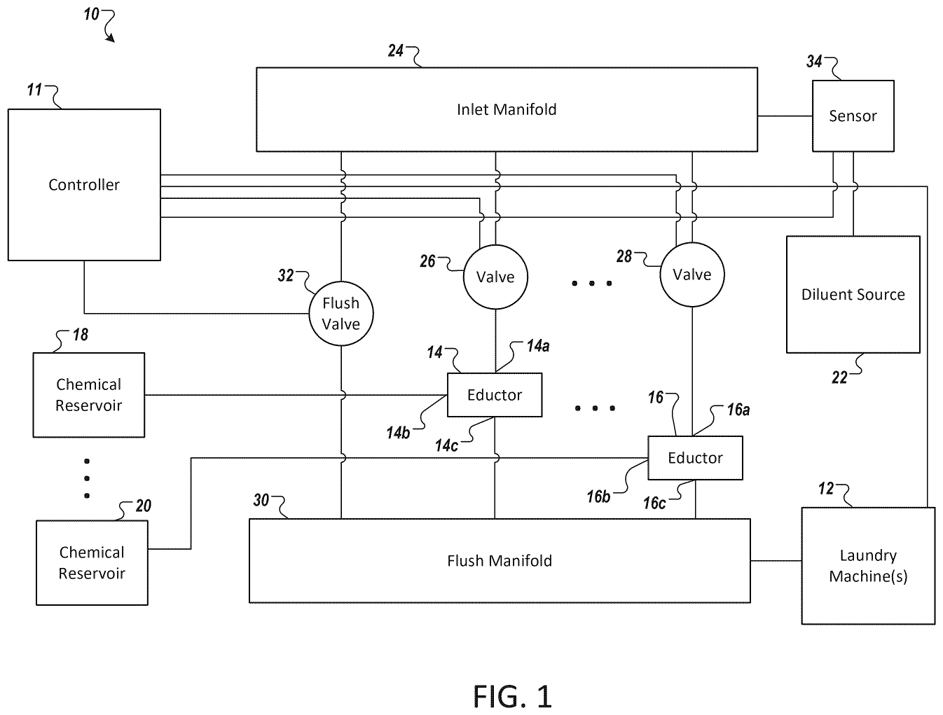

FIG. 1 is a block diagram of an example chemical dispensing system 10. The system 10 includes a controller 11 and multiple eductors 14, 16. The eductors 14, 16 draw chemicals from one or more chemical reservoirs 18, 20 to mix with diluent (e.g., water) from a diluent source 22. The system 10 is configured to dispense chemical solutions to a point of use, such as laundry machine(s) 12. Alternatively, or additionally, the system 10 can dispense chemicals into other types of machines or receptacles (e.g., spray bottles, chemical containers, etc.).

The system 10 includes an inlet manifold 24 fluidly coupled to the diluent source 22. Selector valves 26, 28 are operable to control flow of the diluent from the inlet manifold 24 to respective eductors 14,16. The selector valves 26, 28 can be electrically controlled or pneumatically controlled. The selector valves 26, 28 can also have a manual override enabling manual actuation of the selector valves 26, 28. In an open position, the selector valves 26, 28 allow diluent to flow to the respective eductor 14, 16, and in a closed position, the selector valves 26, 28 block diluent flow from entering the respective eductor 14, 16. In operation, the selector valves 26, 28 can be operated individually, one at a time (e.g., sequentially).

A sensor 34 is configured to measure a flow characteristic of the diluent flow. As shown in FIG. 1, the sensor 34 is coupled upstream of the diluent inlet of the eductor (e.g., between the diluent source 22 and the inlet manifold 24) and configured to measure the flow characteristic of the flow of diluent; however, the sensor can be disposed at other locations within the system 10. Including the sensor upstream of the eductors 14, 16 can reduce performance issues of the sensor related to interactions with chemicals (e.g., corrosion, chemical attack, chemical build up). Including the sensor upstream of the eductors 14, 16 can also reduce variations related to altered fluid properties resulting from the mixing of the diluent with various chemicals. In some implementations, the sensor 34 is a pressure sensor and is configured to measure a static or dynamic pressure of the diluent flow. In some implementations, the sensor 34 is a flow meter and is configured to measure a flow rate of the diluent flow. In some implementations, the system 10 includes both a pressure sensor and a flow meter. Both the pressure sensor and flow meter can be coupled to the system upstream of the eductors 14, 16.

Each eductor 14, 16 includes a diluent inlet 14a, 16a coupled to the respective selector valve 26, 28, a chemical pickup port 14b, 16b, and a discharge port 14c, 16c. The eductors 14, 16 include a venturi fluidly coupling the diluent inlet 14a, 16a and the discharge port 14c, 16c. When diluent flows through the eductor 14, 16, the venturi reduces the pressure in the diluent flow generating a suction pressure at the chemical pickup port 14b, 16b. The suction pressure draws chemical from the respective chemical reservoirs 18, 20. The chemical drawn into the eductors 14, 16 from the chemical reservoirs 18, 20 mixes with the diluent flow within the eductors 14, 16.

The discharge ports 14c, 16c are fluidly coupled to a flush manifold 30. While dispensing chemicals, the eductors 14, 16 discharge the chemical solution into the flush manifold 30. The flush manifold 30 is fluidly coupled to the laundry machine(s) 12 and configured to dispense the chemical solutions to the laundry machine(s) 12.

As shown in FIG. 1, the system 100 includes a flush valve 32. The flush valve 32 allows diluent to flow from the inlet manifold to the flush manifold to flush chemical solutions and remnants of dispensed chemicals out of the flush manifold to prevent cross contamination of chemicals. The flush valve 32 is typically the farthest inlet to the flush manifold from the outlet of the flush manifold. In some implementations, an eductor (e.g., eductor 14) is configured as a flush eductor. A flush eductor either has no chemical reservoir connected to the chemical pickup port (e.g., the chemical pickup port is blocked) or the chemical pickup port is coupled to a source of diluent. In such implementations, the selector valve coupled to the flush eductor (e.g., selector valve 26) functions as the flush valve.

The system 10 can be operated by interfacing the controller 11 with the laundry machines 12. The laundry machines 12 provide signals to request the dispensing of chemicals per multiple formulas per machine. When a qualified signal is detected by the controller 11, the unit can dose the appropriate products routed to the requesting laundry machine according to the settings of the formula and the washing phase being executed. A qualified signal, for example, is a signal that meets specified criteria (e.g., signal content, signal amplitude, signal duration). The specified criteria can be determined to reduce effects of signal noise and incidences of false triggers causing chemicals to be erroneously dispensed.

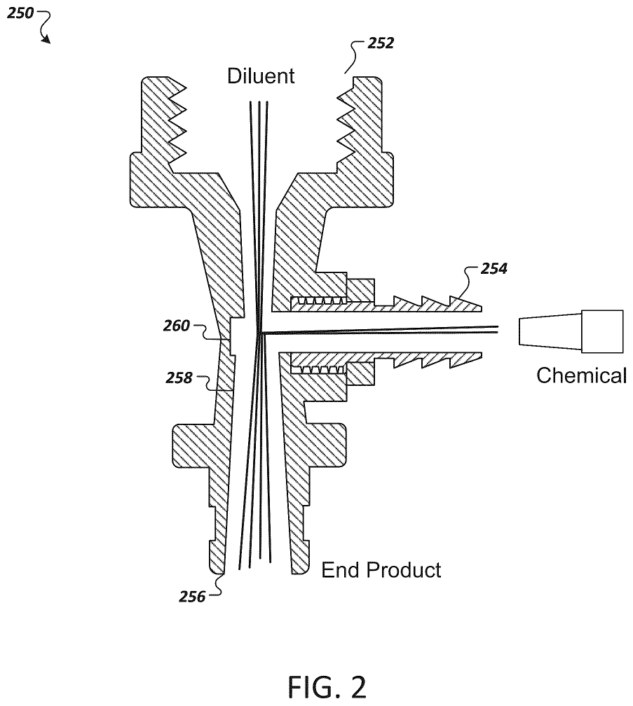

FIG. 2 is a cross-section schematic of an example eductor 250 for use in a chemical dispensing system (e.g., eductor 14, 16). The eductor 250 includes a diluent inlet 252, a chemical pickup port 254, and a discharge port 256. A venturi 258 fluidly couples the diluent inlet 252 and the discharge port 256. The chemical pickup port 254 is located near the throat 260 of the venturi 258. As diluent flows through the venturi 258, the pressure at the throat of the venturi 258 is reduced generating a suction pressure at the chemical pickup port 254. Chemical is drawn into the eductor 250 through the chemical pickup port 254. The chemical mixes with the diluent and discharges through the discharge port 256.

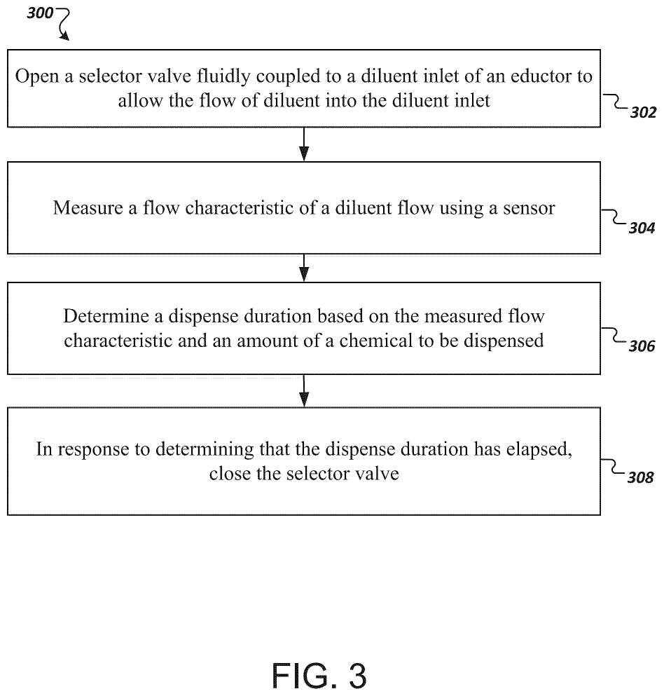

FIG. 3 is a flow chart of an example process 300 for dispensing chemicals using a chemical dispensing system (e.g., system 10). The process 300 is generally described in the context of the other figures in this description. For example, the process 300 can be performed by the controller 11 shown in FIG. 1 or the control system 1200 shown in FIG. 12. However, the process 300 may be performed by any suitable system, software, and hardware as appropriate. In some implementations, the process 300 can be run in parallel, in combination, in loops, or in any order.

The controller receives a signal or a command to dispense an amount of a particular chemical. For example, the controller receives the command to dispense a particular chemical from a laundry machine during a wash cycle. The command can include an identifier for the particular chemical and a volume of the requested dose. In implementations where the dispensing system is configured to supply chemicals to multiple different laundry machines, the signal can include an identifier for the particular laundry machine sending the signal or command.

The controller opens a selector valve fluidly coupled to a diluent inlet of an eductor to allow the flow of diluent into the diluent inlet (step 302). For example, the controller sends a signal to the selector valve to cause the selector valve to move from a closed position to an open position. The selector valve can be actuated, for example, by a solenoid.

The controller measures a flow characteristic of a diluent flow using a sensor (step 304). For example, the controller receives a signal from the sensor indicating a value of the flow characteristic. In some implementations, the sensor is a pressure sensor, and the controller measures a dynamic pressure of the diluent flow. In some implementations, the pressure sensor measures a static pressure of the diluent flow and a correlation between the static and dynamic pressure (which can depend on the type of eductor used) can be used to determine the dynamic pressure. In some implementations, the sensor is a flow meter, and the controller measures a flow rate of the diluent flow. In some implementations, the controller measures both a pressure and a flow rate of the diluent flow.

The controller can open the selector valve, and after a predetermined amount of time (e.g., 0.1 seconds or more, 0.5 seconds or more, 1 second or more, 2 seconds or more), the controller can obtain a signal from the sensor indicating the value of the flow characteristic.

Opening the selector valve before measuring the flow characteristic can allow for the diluent flow to start flowing through the eductor and reach a steady state flow condition. For example, when the diluent flow is not in a steady state flow condition, the measured flow characteristic may not reflect the actual flow conditions throughout the dispense duration, and the controller may determine an inadequate dispense duration resulting in dispensing too little or too much chemical. The controller then determines the dispense duration taking into account the predetermined amount of time. For example, the controller accesses a chemical signature for the particular chemical from memory or a data store. The controller determines the expected flow rate of the particular chemical that corresponds with the measured flow characteristic using the accessed chemical signature. The controller determines a dispense duration based on the determined expected chemical flow rate and the amount of chemical to be dispensed. The controller can subtract the predetermined amount of time from the determined dispense duration to determine the remaining amount of time required to achieve the desired dose.

In some implementations, the controller continuously receives a signal from the sensor indicating the value of the flow characteristic. For example, the controller can receive an analog signal from the flow dispenser that continuously (e.g., without interruption) varies in time. Alternately, the controller can receive a discrete signal (e.g., a digital signal) at a constant rate (e.g., 1 hertz (Hz) or more, 10 Hz or more, 100 Hz or more, 1 kilohertz (kHz) or more). The controller can average signals received during the predetermined amount of time to determine an average value of the flow characteristic.

The controller determines a dispense duration based on the measured flow characteristic and an amount of a particular chemical to be dispensed (step 306). For example, the controller accesses, from memory, calibration data associated with the particular chemical. The calibration data can include a curve (e.g., a chemical signature) that indicates a chemical flow rate based on a diluent pressure or a diluent flow rate. For example, the chemical signature can associate the expected flow rate of a particular type of chemical through an eductor chemical pickup port as a function of the measured flow characteristic. The controller can determine the dispense duration based on the amount of the particular chemical and the chemical flow rate associated with the measured diluent pressure or diluent flow rate. For example, the controller accesses a chemical signature for the particular chemical from memory or a data store. The controller determines the expected flow rate of the particular chemical that corresponds with the measured flow characteristic using the accessed chemical signature. The controller determines a dispense duration based on the determined expected chemical flow rate and the amount of chemical to be dispensed.

The calibration data can be generated in a laboratory setting and stored in the memory of the controller. In some implementations, the controller can access calibration data from a cloud storage location. In some implementations, the calibration data stored in the memory of the controller can be updated through a portable storage device (e.g., a USB drive) or in real-time through a computing device connected to a network (e.g., a wired or wireless network) that accesses updated calibration data from a cloud storage location (e.g., a remote server).

In response to determining that the dispense duration has elapsed, the controller closes the selector valve. For example, the controller can start a timer when the controller opens the selector valve. When the determined dispense duration has elapsed on the timer, the controller send a signal to the selector valve to cause the selector valve to move from the open position to the closed position.

The controller can open a flush valve to flush a flush manifold of the chemical dispensing system. For example, the controller generates a signal to cause the flush valve to move from a closed position to an open position after the selector valve is closed. After determining that a flush duration has elapsed, the controller can close the flush valve. The flush operation can help prevent cross-contamination of chemicals and can keep the discharge ports of the eductors free from chemical buildup or other debris. The flush duration can be a set period of time. In some implementations, the flush duration is based on a length of the discharge hose connecting the chemical dispensing system to the laundry machine. The controller can adjust the flush duration. For example, the controller can determine the flush duration based on the measured flow characteristic. Alternately, or additionally, the controller can determine the flush duration based on if the discharge hose needs additional flushing.

The process 300 can include dispensing two or more chemicals. For example, after dispensing a first chemical, the controller can determining a second dispense duration to dispense a second chemical fluidly coupled to the pickup port of a second eductor. The second dispense duration is based on the measured flow characteristic and an amount of the second chemical to be dispense and can be different than the first dispense duration. The controller opens the second selector valve; and in response to determining that the second dispense duration has elapsed, closes the second selector valve.

In some implementations, the controller performs a flush operation between each chemical that is dispensed. For example, the controller can perform a flush operation between chemicals being dispensed when a barrier is needed between the two diluted chemicals or if there is a significant time (e.g., a time that would delay the delivery of a chemical to a laundry machine beyond a chemical delivery window of the wash operation). The duration of each flush operation can be associated with a flush duration. The flush duration can be a fixed time interval. The flush duration can be based on the length of discharge hose that connects the chemical dispensing system with the laundry machines.

In some implementations, the controller can determine that the measured flow characteristic is outside of an operating range of the eductor. For example, the controller can determine that a measured pressure of the diluent flow is outside of a designed operating range (e.g., 30-80 psi) of the eductor. For example, the measured pressure can be above (e.g., 85 psi) or below (e.g., 20 psi) the operating range. Alternatively, or additionally, the controller can determine that a flow rate of the diluent flow is outside of the designed operating range of the eductor.

In response to determining that the measured flow characteristic is outside of the operating range of the eductor. The controller can generate an alert indicating that the measured flow characteristic is outside of the operating range. For example, the controller can generate an alert that includes causing a light on a control panel of the system to blink, an audible alarm, and/or a text-based message (e.g., email, short messaging service (SMS) message) sent to an operator of the system (e.g., a laundry supervisor). In some implementations, the controller generates an alert indicating that the flow of diluent is too low (e.g., the diluent pressure and/or the diluent flow rate are below threshold values of pressure and/or flow rate) to effectively flush the dispensed chemicals from the pipe.

In some implementations, the controller opens a discharge valve associated with the particular laundry machine that sent the dispense signal or command to allow the chemical being dispensed to be discharged into the particular laundry machine. For example, the controller identifies the particular laundry machine based on a unique identifier included in the dispense signal or command. The controller sends a command to open the discharge valve corresponding with the particular machine based on the unique identifier. The controller can open the discharge valve before opening the selector valve. The controller can close the discharge valve after closing the selector valve. In some implementations, the controller can open the discharge valve before opening a selector valve to begin a sequence of dispense and flush operations requested by the particular machine and close the discharge valve after completing the sequence of dispense and flush operations.

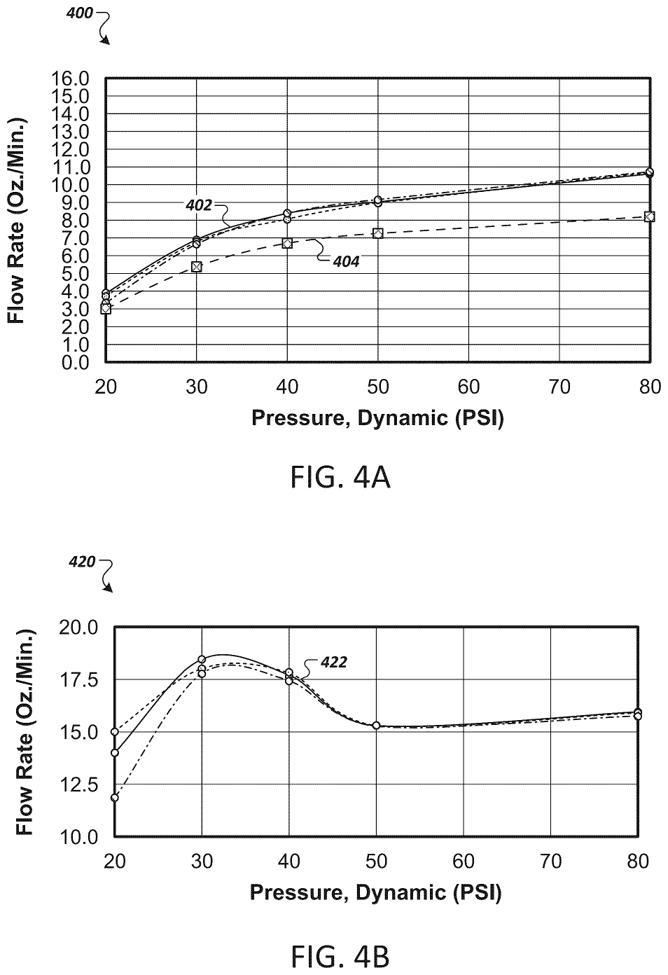

FIGS. 4A-4B show example plots 400, 420 of chemical signatures that associate the chemical flow rate with the diluent pressure. Plot 400 is an example of a rising chemical signature 402. A rising chemical signature can be indicative of a chemical with a higher viscosity. In this example, the chemical flow rate increases with increasing diluent pressure. The slope of the chemical signature 402 increases more steeply for lower pressures than for higher pressures. Chemical signature 404 represents the effects of system configuration on the chemical signature. For example, a chemical dispensing system with a longer discharge hose (e.g., 10 meters or longer) can result in a slightly reduced chemical flow rate across the range of dynamic pressures of the diluent. Generating chemical signatures for various standardized system configurations can increase dispense accuracy by determining the dispense time based on the chemical and the system configuration (e.g., increasing dispense duration for longer discharge hoses).

Plot 420 is an example of a fluctuating chemical signature 422. A fluctuating chemical signature can indicate a lower viscosity (e.g., water). In this example, the flow rate initially increases to a maximum, then decreases, and then increases again as the diluent pressure increases. In some cases, a low viscosity chemical may have a rising signature and a high viscosity chemical may have a fluctuating signature, for example, due to non-Newtonian or viscoelastic effects in the chemicals.

Plots 400, 420 also demonstrate the effects of dispense accuracy of determining the dispense duration based on a flow characteristic of the diluent. For example, if a chemical dispensing system was calibrated using only a single diluent pressure (e.g., 50 psi), for the rising chemical signature 402, the system would dispense less chemical than expected if the diluent pressure is less than 50 psi, and the system would dispense more chemical than expected if the diluent pressure is more than 50 psi. For a chemical with a fluctuating chemical signature, the effects can be less predictable. For example, if the system was calibrated at a diluent pressure of 50 psi, then then the system would almost always dispense more chemical than expected except at low diluent pressures (e.g., less than 30 psi). Alternatively, if the system was calibrated at 30 psi, then the system would almost always dispense less chemical than expected. By calibrating at multiple pressures, the system can account for the differences in chemical flow rate caused by differences in diluent pressure to dispense an accurate chemical dose across the operating range of the eductor.

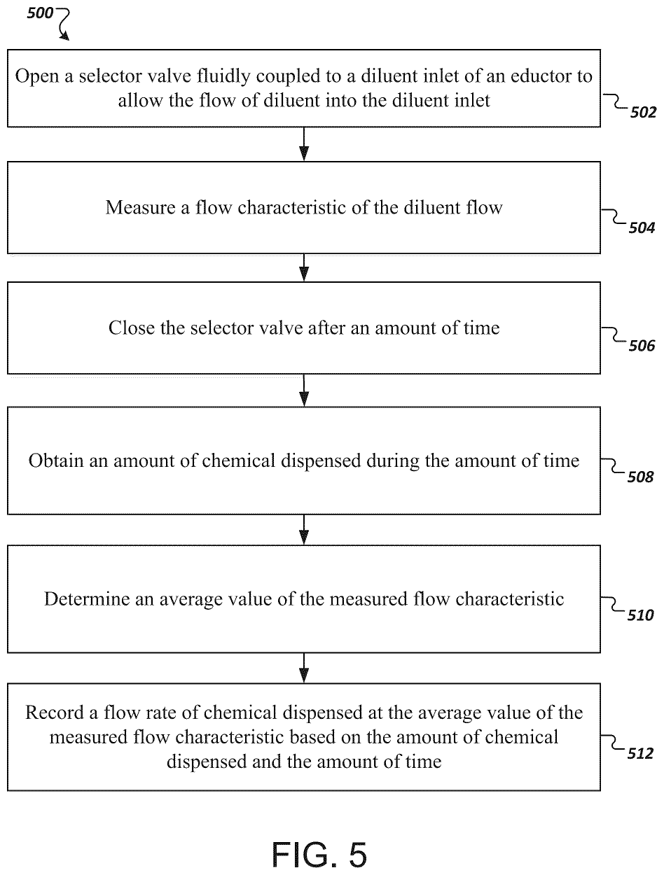

FIG. 5 is a flow chart for an example method 500 for calibrating a chemical dispensing system (e.g., chemical dispensing system 10). The method 500 is generally described in the context of the other figures in this description. For example, the method 500 can be performed by the controller 11 shown in FIG. 1 or the control system 1200 shown in FIG. 12. However, the method 500 may be performed by any suitable system, software, and hardware as appropriate. In some implementations, the method 500 can be run in parallel, in combination, in loops, or in any order.

The controller opens a selector valve fluidly coupled to a diluent inlet of an eductor to allow the flow of diluent into the diluent inlet (step 502). The flow of diluent generates a suction pressure at the chemical pickup port of the eductor to draw chemical from a chemical reservoir into the eductor.

The controller measures a flow characteristic of the diluent flow (step 504). For example, the controller receives one or more signals indicating a value of the flow characteristic (e.g., pressure or flow rate) from a sensor (e.g., pressure sensor or flow meter). The controller can record a time-series of values of the flow characteristic while the selector valve is open.

The controller closes the selector valve after an amount of time (step 506). The amount of time can be a predetermined calibration interval (e.g., 1 second or more, 5 seconds or more, 10 seconds or more, 30 seconds or more).

The controller obtains an amount of chemical dispensed during the amount of time (step 508). For example, the chemical reservoir coupled to the eductor can be placed on a scale. The weight of the chemical reservoir before opening the selector valve and the weight of the chemical reservoir after closing the selector valve are recorded. The controller can obtain a volume of chemical dispensed based on the differences in the weights before selector valve is opened and after the selector valve is closed and the density of the chemical. In some implementations, the controller obtains a time-series of values of the weight of the chemical reservoir while the selector valve is open. In some implementations, the controller receives the amount of chemical dispensed as a user input, e.g., through a data entry keypad or other user interface.

The controller determines an average value of the measured flow characteristic (step 510). For example, the controller determines the average value based on the one or more signals received from the sensor (e.g., the time series of values of the flow characteristic).

The controller records a flow rate of chemical dispensed at the average value of the measured flow characteristic based on the amount of chemical dispensed and the amount of time (step 512).

For example, the controller records a starting weight of the chemical reservoir.

The controller opens the selector valve to start the flow of diluent through the eductor. After a period of time has elapsed (e.g., 30 seconds), the controller closes the selector valve. The controller records an ending weight of the chemical reservoir. The controller determines an amount of chemical dispensed by subtracting the ending weight of the chemical reservoir from the starting weight of the chemical reservoir. The controller can convert the weight of the amount of chemical dispensed to a volume of chemical dispensed by dividing the weight by the density of the chemical. The controller determines an average flow rate of the chemical being dispensed by dividing the volume of chemical dispensed by the period of time that the selector valve was open (e.g., 30 seconds).

The controller can iteratively perform the steps of the method 500 for different values of the measured flow characteristic (e.g., for different diluent pressures or diluent flow rates). Based on the iterative performance, the controller can construct a chemical signature curve relating the chemical flow rate to the measured flow characteristic.

The controller can iteratively perform the steps of the method 500 for different standardized system configurations. Standardized system installation configurations can include set values or ranges of various system parameters such as the length and/or inner diameter of the hose connecting chemical reservoirs to eductors, the length and/or inner diameter of the discharge hose connecting the chemical dispensing system to the laundry machines, the height of the chemical reservoir and/or laundry machines relative to the chemical dispensing system, the temperature of the chemical dispensing system and/or chemical storage locations, the condition of the chemical packaging (e.g., open or closed loop). Other components in the installation configuration can also affect the flow rate including machine connections and common accessories (e.g., foot valves, check valves, gate valves, ball valves, etc.). Multiple standardized system configurations can be determined based on various combinations and permutations of the system parameters. Calibration data stored in the memory of the controller can include multiple calibration curves, each calibration curve associated with a particular installation configuration and a particular chemical.

At the time of installation, the installer can store the configuration of the installed system in the memory of the controller. The controller can select the appropriate chemical signature calibration data based on the stored configuration of the installed system.

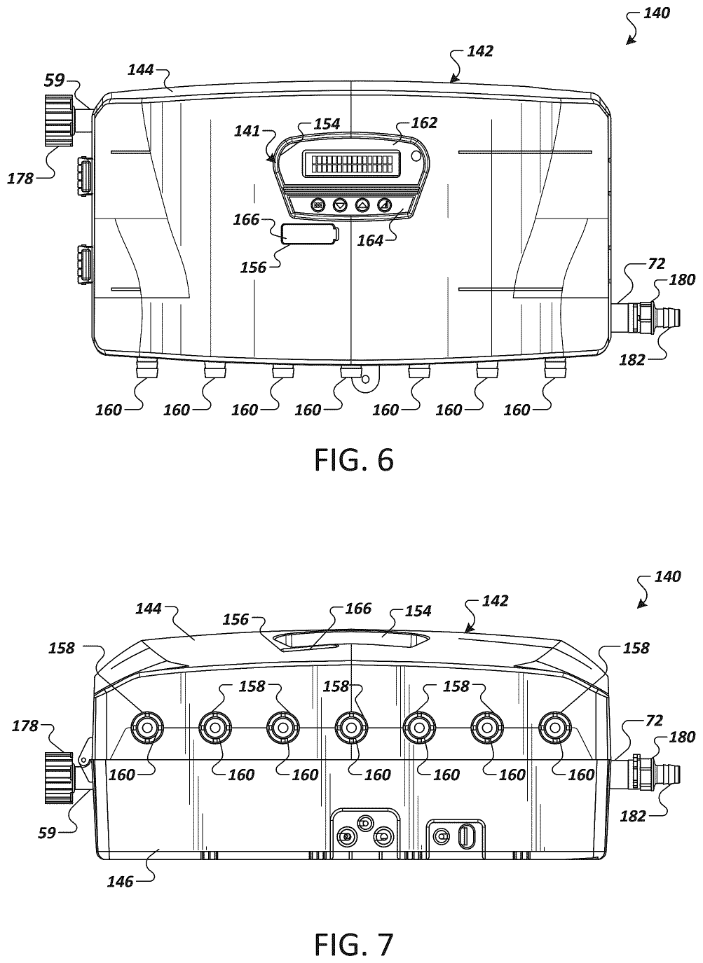

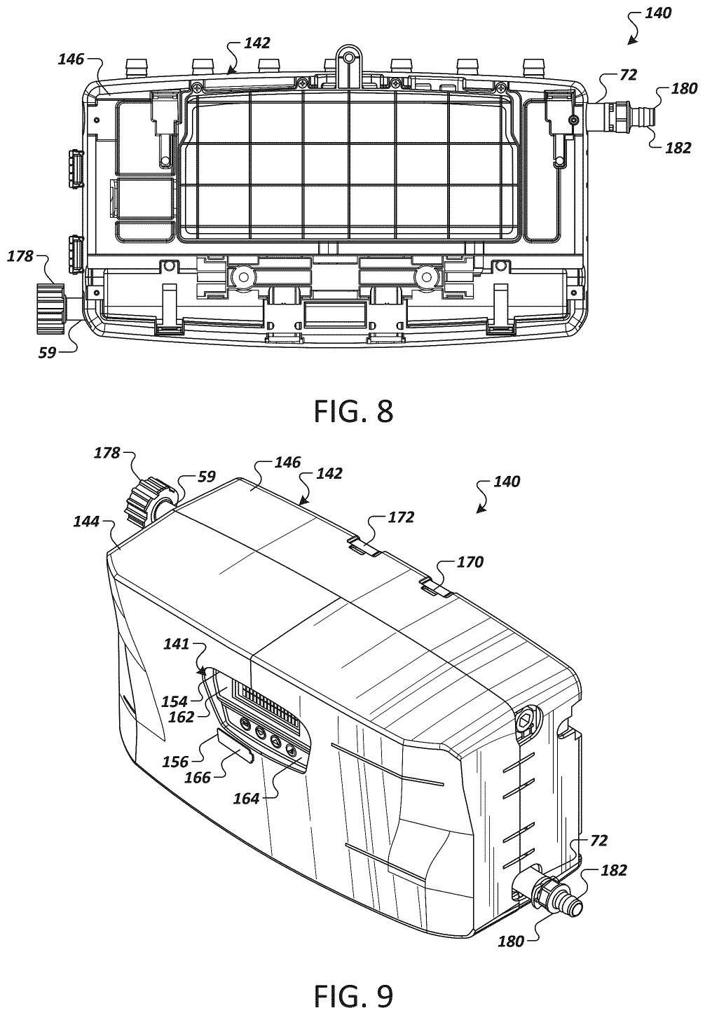

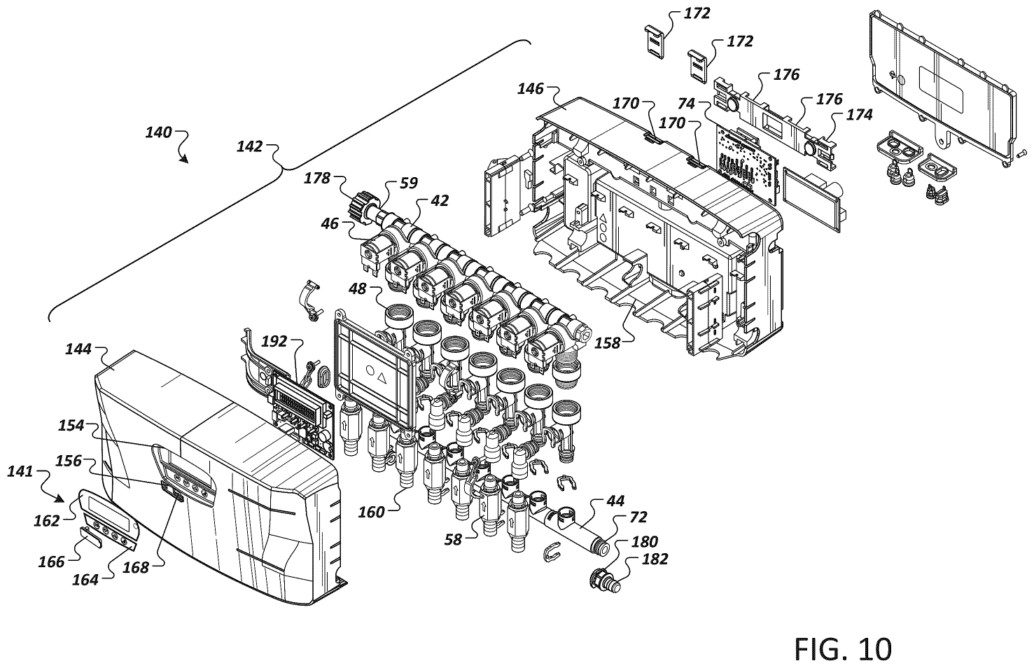

FIGS. 6-10 depict front, bottom, back, perspective, and exploded views, respectively of a dispenser 140 in accordance with an embodiment of the invention. As best shown by FIG. 10, the dispenser 140 includes the inlet manifold 42, flush manifold 44, selector valves 46, eductors 48, check valves 58, and interface circuit 74. The dispenser 140 further includes a user interface 141 (which may be provided by a human machine interface (HMI) of controller 11) and a housing 142 having a front portion 144 and a back portion 146.

The front portion 144 of housing 142 may include openings 154, 156 that provide access to the user interface 141, and the back portion 146 of housing 142 may include openings 158 that provide access to input ports 160 of check valves 58. Recess 154 can provide access to a display 162 that displays information about the operation of the dispenser 140 to the user, and one or more input devices 164 (e.g., buttons) that enable the user to provide data/instructions to the dispenser 140. Opening 156 may include a removeable cover 166 that provides access to a serial data port 168, such as a Universal Serial Bus (USB) port, which is an industry standard communication protocol managed by the USB Implementers Forum.

The back portion 146 of housing 142 may include one or more openings 170 each configured to receive a keeper 172. A mounting bracket 174 may be configured to be mounted to a wall or other support structure and may include one or more slots 176 each configured to receive one of the keepers 172. In operation, the mounting bracket 174 may be affixed to the support structure, and the back portion 146 of housing 142 positioned over the mounting bracket 174. One of the keepers 172 may then be inserted through each opening 170 to engage a respective slot 176 of the mounting bracket 174. The back portion 146 of housing 142 may thereby be removably mounted to the support structure by securing it to the bracket 174.

The input port 59 of inlet manifold 42 may include a threaded connector 178 configured to receive a threaded end of a diluent supply line. In some implementations, quick connect fittings can be included for solid hoses. The output port 72 of flush manifold 44 may include a nozzle 180 configured to receive the dispense line 17 that conveys the output of the dispensing system 10 to the point of use. The nozzle 180 may include one or more circumferential barbs 182 configured to resist movement of the supply line and provide a secure fluid-tight connection between the nozzle 180 and the supply line.

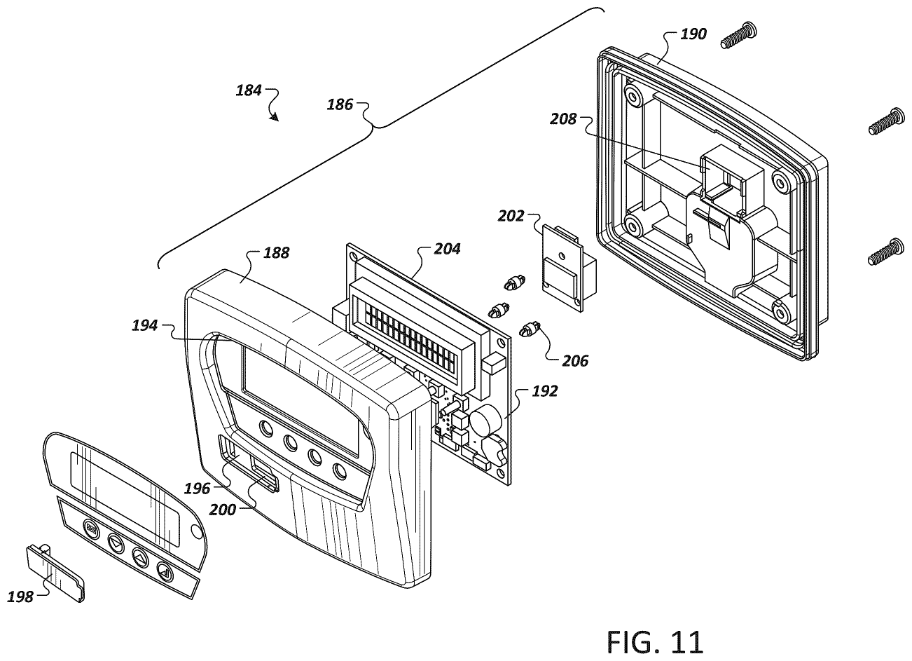

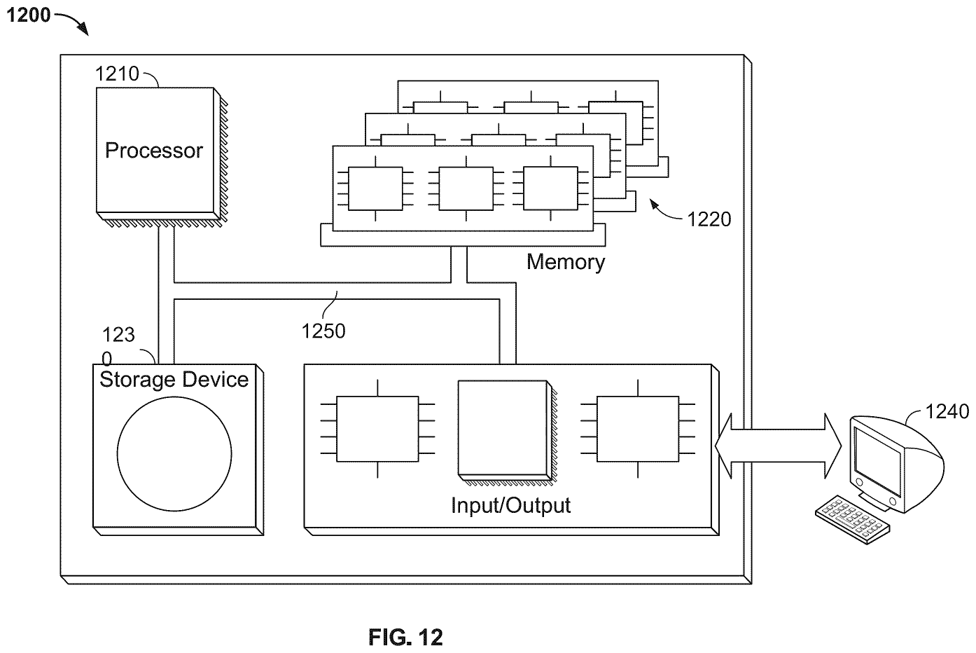

FIG. 11 is an exploded view depicting an example implementation of a controller 184 (e.g., controller 11). The controller 184 can be mounted separately from the dispenser 140.

The controller 184 includes a housing 186 having a front portion 188 and a back portion 190, and a Printed Circuit Board Assembly (PCBA) 192. The PCBA 192 can include an HMI, processor, I/O interface, and memory of controller 11. The front portion 188 of housing 186 may include an opening 194 that provides access to the HMI, and an opening 196 having a removable cover 198 that provides access to a serial data port 200, such as a USB port. A connector 202 can be affixed to a back facing side 204 of PCBA 192 by one or more fasteners 206. The back portion 190 of housing 186 includes an opening 208 configured to receive the connector 202. The opening 208 can enable the I/O interface of PCBA 192 to be electrically coupled to the dispenser 140, for example, by plugging a connectorized multi-conductor cable into the connector 202.

FIG. 12 shows a schematic drawing of a control system 1200 that can be used in the example chemical dispensing systems of FIGS. 1 and 6-10 according to the present disclosure. For example, all or parts of the control system (or controller) 1200 can be used for the operations described previously, for example as or as part of the controller 11 or 184. The control system 1200 is intended to include various forms of digital processing systems such as computers programmable logic controllers (PLC), printed circuit boards (PCB), processors, digital circuitry, or otherwise. Additionally, the system can include portable storage media, such as, Universal Serial Bus (USB) flash drives. For example, the USB flash drives can store operating systems and other applications. The USB flash drives can include input/output components, such as a wireless transmitter or USB connector that can be inserted into a USB port of another computing device.

The control system 1200 includes a processor 1210, a memory 1220, a storage device 1230, and an input/output device 1240. Each of the components 1210, 1220, 1230, and 1240 are interconnected using a system bus 1250. The processor 1210 is capable of processing instructions for execution within the control system 1200. The processor can be designed using any of a number of architectures. For example, the processor 1210 can be a CISC (Complex Instruction Set Computers) processor, a RISC (Reduced Instruction Set Computer) processor, or a MISC (Minimal Instruction Set Computer) processor.

In one implementation, the processor 1210 is a single-threaded processor. In another implementation, the processor 1210 is a multi-threaded processor. The processor 1210 is capable of processing instructions stored in the memory 1220 or on the storage device 1230 to display graphical information for a user interface on the input/output device 1240.

The memory 1220 stores information within the control system 1200. In one implementation, the memory 1220 is a computer-readable medium. In one implementation, the memory 1220 is a volatile memory unit. In another implementation, the memory 1220 is a non-volatile memory unit.

The storage device 1230 is capable of providing mass storage for the control system 1200. In one implementation, the storage device 1230 is a computer-readable medium. In various different implementations, the storage device 1230 can be a floppy disk device, a hard disk device, an optical disk device, a tape device, flash memory, a solid state device (SSD), or a combination thereof.

The input/output device 1240 provides input/output operations for the control system 1200. In one implementation, the input/output device 1240 includes a keyboard and/or pointing device. In another implementation, the input/output device 1240 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, e.g., both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including e.g., semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information (e.g., a formula editor) to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them.

The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, cellular networks, and the Internet.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation.

Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous.

Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications can be made without departing from the spirit and scope of the disclosure. For example, example operations, methods, or processes described herein can include more steps or fewer steps than those described. Further, the steps in such example operations, methods, or processes can be performed in different successions than that described or illustrated in the figures. Accordingly, other implementations are within the scope of the following claims.

What is claimed is:

1. A chemical dispensing system comprising:
an eductor having a diluent inlet, a chemical pickup port, a discharge port, and a venturi fluidly coupled between the diluent inlet and the discharge port;
a selector valve fluidly coupled to the diluent inlet and configured to control a flow of diluent into the diluent inlet;
a sensor configured to measure a flow characteristic of the flow of diluent;
a controller operatively coupled to the selector valve, the controller comprising at least one processor and memory storing instructions that, when executed, cause the at least one processor to perform operations comprising:
opening the selector valve to allow the flow of diluent into the diluent inlet;
determining a dispense duration based on the measured flow characteristic and an amount of a chemical to be dispensed; and
in response to determining that the dispense duration has elapsed, closing the selector valve.

2. The chemical dispensing system of claim 1, wherein the sensor comprises a pressure sensor coupled to the system upstream of the diluent inlet and the flow characteristic comprises a pressure of the flow of diluent.

3. The chemical dispensing system of claim 2, further comprising:
a flow meter coupled to the system upstream of the diluent inlet and configured to measure a flow rate of the flow of diluent.

4. The chemical dispensing system of claim 1, wherein the sensor comprises a flow meter coupled to the system upstream of the diluent inlet and the flow characteristic comprises a flow rate of the flow of diluent.

5. The chemical dispensing system of claim 1, wherein the memory of the controller stores dispense duration calibration data, and
wherein the calibration data comprises a plurality of curves of chemical flow rates based on the measured flow characteristic, each curve corresponding with a particular chemical.

6. The chemical dispensing system of claim 5, wherein the calibration data further comprises a plurality of curves of chemical flow rates based on an installation configuration of the chemical dispensing system, each curve corresponding to a particular installation configuration and a particular chemical.

7. The chemical dispensing system of claim 5, wherein determining the dispense duration comprises determining an expected flow rate of the particular chemical to be dispensed based on the measured flow characteristic; and determining the dispense duration based on the flow rate and the amount of the chemical to be dispensed.

8. The chemical dispensing system of claim 1, wherein the discharge port is fluidly coupled to one or more laundry machines.

9. The chemical dispensing system of claim 1, wherein the selector valve is a first selector valve and the eductor is a first eductor, and the system further comprises:
a second eductor having a diluent inlet, a chemical pickup port, a discharge port, and a venturi fluidly coupled between the diluent inlet and the discharge port;
a second selector valve fluidly coupled to the diluent inlet of the second eductor
an inlet manifold fluidly coupled to the first and second selector valves and configured to be coupled to a source of diluent; and
a flush manifold fluidly coupled to the discharge ports of the first and second eductors.

10. The chemical dispensing system of claim 9, wherein the chemical pick up ports of the first and second eductors are fluidly coupled to different chemical reservoirs.

11. The chemical dispensing system of claim 9, wherein the second eductor is a flush eductor, and wherein the operations further comprise:
opening the second selector valve for a flush duration to flush the flush manifold with diluent.

12. The chemical dispensing system of claim 9, wherein the operations further comprise:
determining a second dispense duration to dispense a second chemical fluidly coupled to the pickup port of the second eductor;
opening the second selector valve for the second dispense duration; and
in response to determining that the second dispense duration has elapsed, closing the second selector valve.

13. A method for dispensing a fluid, the method comprising:
opening a selector valve fluidly coupled to a diluent inlet of an eductor to allow the flow of diluent into the diluent inlet, the eductor comprising the diluent inlet, a chemical pickup port, a discharge port and a venturi fluidly coupled between the diluent inlet and the discharge port;
measuring a flow characteristic of a diluent flow using a sensor;
determining a dispense duration based on the measured flow characteristic and an amount of a chemical to be dispensed; and
in response to determining that the dispense duration has elapsed, closing the selector valve.

14. The method of claim 13, wherein the sensor comprises a pressure sensor and measuring the flow characteristic comprises measuring a pressure of the flow of diluent, and
wherein the method further comprises measuring a flow rate of the flow of diluent using a flow meter fluidly coupled to the diluent inlet.

15. The method of claim 13, wherein measuring the flow characteristic comprises:
determining an average value of the flow characteristic over a period of time, and
wherein determining the dispense duration is based on the average value of the flow characteristic.

16. The method of claim 13, wherein determining the dispense duration comprises determining a flow rate of the chemical to be dispensed based on the measured flow characteristic; and determining the dispense duration based on the flow rate and the amount of the chemical to be dispensed.

17. The method of claim 13, further comprising:
opening a second selector valve to flush a flush manifold with diluent; and in response to determining that a flush duration has elapsed, closing the second selector valve.

18. The method of claim 13, further comprising:
determining a second dispense duration to dispense a second chemical fluidly coupled to the pickup port of a second eductor, the second dispense duration being based on the measured flow characteristic and an amount of the second chemical to be dispensed;
opening a second selector valve; and
in response to determining that the second dispense duration has elapsed, closing the second selector valve.

19. A method for calibrating a chemical dispensing system, the method comprising:
opening a selector valve fluidly coupled to a diluent inlet of an eductor to allow a flow of diluent into the diluent inlet;
measuring a flow characteristic of the flow of diluent;
closing the selector valve after an amount of time;
obtaining an amount of chemical dispensed during the amount of time;
determining an average value of the measured flow characteristic; and
recording a flow rate of the chemical dispensed at the average value of the measured flow characteristic based on the amount of chemical dispensed and the amount of time.

20. The method of claim 19, further comprising:
for a plurality of different installation configurations, iteratively performing
opening the selector valve fluidly coupled to the diluent inlet of an eductor to allow the flow of diluent into the diluent inlet;
measuring the flow characteristic of the flow of diluent;
closing the selector valve after an amount of time;
obtaining the amount of chemical dispensed during the amount of time;
determining the average value of the measured flow characteristic; and
recording the flow rate of the chemical dispensed at the average value of the measured flow characteristic based on the amount of chemical dispensed and the amount of time.
